(19) United States
(12) Patent Application Publication
(10) Pub. No.: US 2015/0235666 A1
(43) Pub. Date: Aug. 20, 2015

(54) SPINDLE MOTOR AND RECORDING DISK DRIVING DEVICE INCLUDING THE SAME

(71) Applicant: SAMSUNG ELECTRO-MECHANICS CO., LTD., Suwon-Si (KR)

(72) Inventors: Kwan Soo Yun, Suwon-Si (KR); Ji Hye Kim, Suwon-Si (KR); Sung Tai Jung, Suwon-Si (KR); Duck Shik Kim, Suwon-Si (KR)

(73) Assignee: SAMSUNG ELECTRO-MECHANICS CO., LTD., Suwon-Si (KR)

(21) Appl. No.: 14/612,211

(22) Filed: Feb. 2, 2015

(30) Foreign Application Priority Data
Feb. 14, 2014 (KR) 10-2014-0017117

(51) Int. Cl. G11B 19/20; H02K 1/16; H02K 5/06; H02K 5/22

(52) U.S. Cl. CPC G11B 19/2009; H02K 5/22; H02K 1/165; H02K 5/06

(57) ABSTRACT

There is provided a spindle motor including: a base member including an installation part extended upwardly in an axial direction and a coupling hole formed to be disposed around the installation part; a stator core including winding grooves into which a coil is inserted and wound therearound and protrusion parts formed on a surface opposite to a surface in which the wounding groove is formed, and fixedly installed in the installation part; and a strength reinforcing member including a concave groove formed therein so as to be disposed to face the protrusion part, and coupled to the coupling hole in order to reinforce strength of the base member.

### CROSS-REFERENCE TO RELATED APPLICATION

This application claims the priority and benefit of Korean Patent Application No. 10-2014-0017117 filed on Feb. 14, 2014, with the Korean Intellectual Property Office, the disclosure of which is incorporated herein by reference.

### BACKGROUND

The present disclosure relates to a spindle motor and a recording disk driving device including the same.

A hard disk drive (HDD), an information storage device, reads data stored on a disk or writes data to a disk using a read/write head.

A hard disk drive as described above requires a disk driving device capable of driving the disk. In such a disk driving device, a small-sized motor is commonly used.

That is, a disk is mounted on the motor, and at the time of rotation of the motor, at the time of driving the motor, the disk rotates, such that data stored in the disk can be read or data can be written to a disk.

In addition, the motor rotating the disk, a device converting electrical energy into mechanical energy using force applied to a conductor having a current flowing therein within a magnetic field, basically generates driving force rotating the disk by electromagnetic interaction between a magnet and a coil.

In addition, the coil is wound around a stator core, and the stator core is installed on a base member so as to face the magnet. That is, the stator core is installed on a base member so as to be disposed in a space formed by the base member and a rotor hub on which the magnet is mounted.

Meanwhile, as hard disk drives have tended to be thinned, motors thereof have also tended to be miniaturized and thinned.

However, there is a limitation in implementing thinning due to the coil wound around the stator core. That is, since the coil wound around the stator core to be installed on the base member should be spaced apart from the base member by a predetermined interval, a space corresponding to a height of the stator core including the coil wound therearound is required. Therefore, the development of a structure capable of reducing an increase in a thickness of the motor due to the stator core including the coil wound therearound has been demanded.

In addition, in the case of adopting a structure in which the rotor hub including the magnet mounted thereon is disposed in a groove of the base member as disclosed in Japanese Patent Laid-Open No. 2008-109793, a thickness of the base member is reduced by the formation of the groove, such that rigidity of the base member may be deteriorated.

### RELATED ART DOCUMENT

### (Patent Document 1) Japanese Patent Laid-Open Publication No. 2008-109793

### (Patent Document 2) U.S. Patent Application Publication No. 2012/0033328

### SUMMARY

An aspect of the present disclosure may provide a spindle motor capable of preventing rigidity from being deteriorated while having thinness implemented therein, and a recording disk driving device including the same.

According to an aspect of the present disclosure, a spindle motor may include: a base member including an installation part extended upwardly in an axial direction and a coupling hole formed to be disposed around the installation part; a stator core including winding grooves into which a coil is inserted and wound therearound and protrusion parts formed on a surface opposite to a surface in which the wounding groove is formed, and fixedly installed in the installation part; and a strength reinforcing member including a concave groove formed therein so as to be disposed to face the protrusion part, and coupled to the coupling hole in order to reinforce strength of the base member.

The base member may be formed by die-casting, and the strength reinforcing member may be formed of a metal material.

The winding groove and the protrusion part may be formed by press processing.

The strength reinforcing member may have a ring shape.

A plurality of concave grooves may be disposed to be spaced apart from each other in a circumferential direction.

The plurality of concave grooves may have a circular ring shape.

According to another aspect of the present disclosure, a spindle motor may include: a base member including an installation part extended upwardly in an axial direction and a coupling hole formed to be disposed around the installation part; and a stator core including winding grooves into which a coil is inserted and wound therearound and protrusion parts formed on a surface opposite to a surface in which the wounding groove is formed, and fixedly installed in the installation part, wherein the concave groove is formed in a strength reinforcing member.

The strength reinforcing member may be formed of a metal material, and the base member may be formed together with the strength reinforcing member by insert injection molding.

According to another aspect of the present disclosure, a recording disk driving device may include: the spindle motor as described above; a head transfer part transferring a head detecting information stored on the recording disk mounted in the spindle motor to the recording disk; and an upper case coupled to a base member provided in the spindle motor so as to form an internal space for accommodating the spindle motor and the head transfer part.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic cross-sectional view showing a spindle motor according to an exemplary embodiment of the present disclosure;

FIG. 2 is an enlarged view of part A of FIG. 1;

FIG. 3 is a perspective view showing a strength reinforcing member provided in the spindle motor according to an exemplary embodiment of the present disclosure;

FIG. 4 is a perspective view showing a stator core provided in the spindle motor according to an exemplary embodiment of the present disclosure;

FIG. 5 is a schematic cross-sectional view showing a spindle motor according to another exemplary embodiment of the present disclosure; and

FIG. 6 is a schematic cross-sectional view showing a recording disk driving device according to an exemplary embodiment of the present disclosure.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

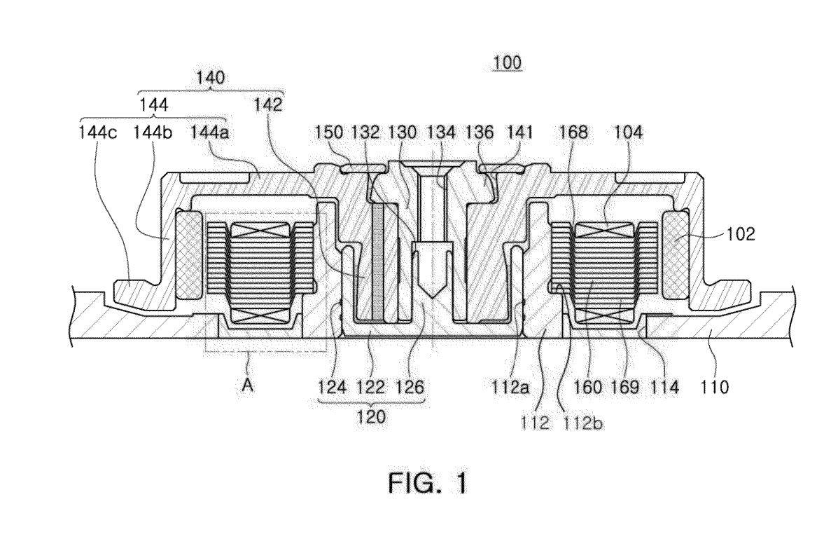

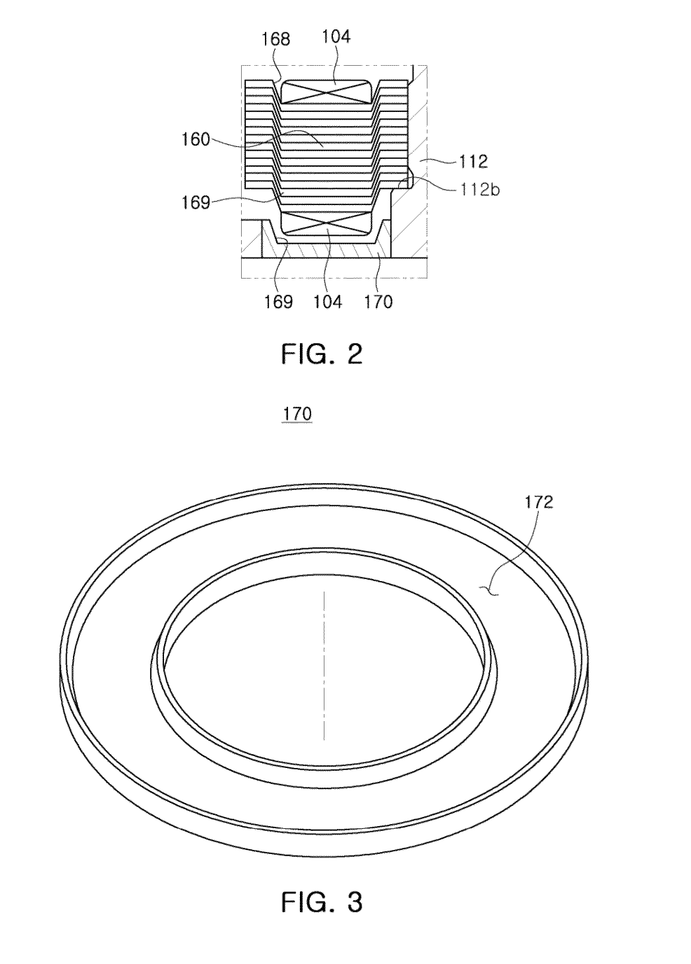

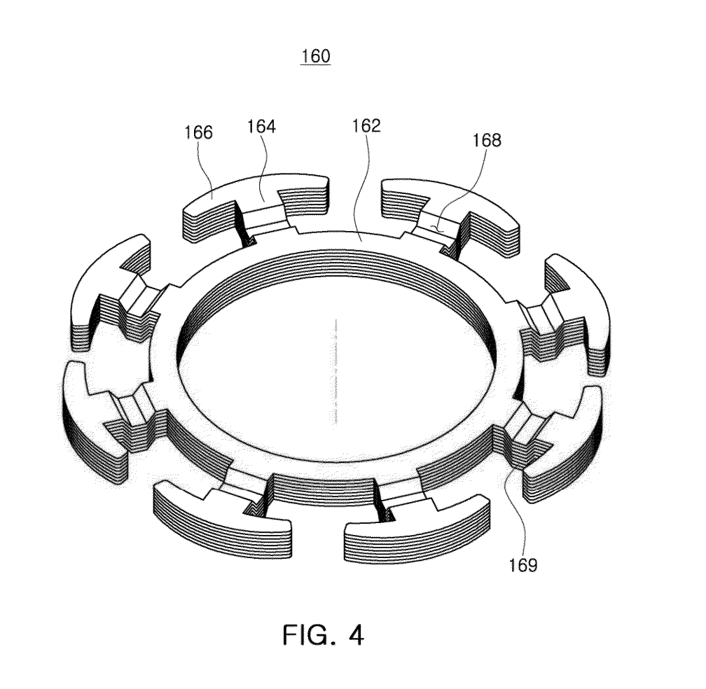

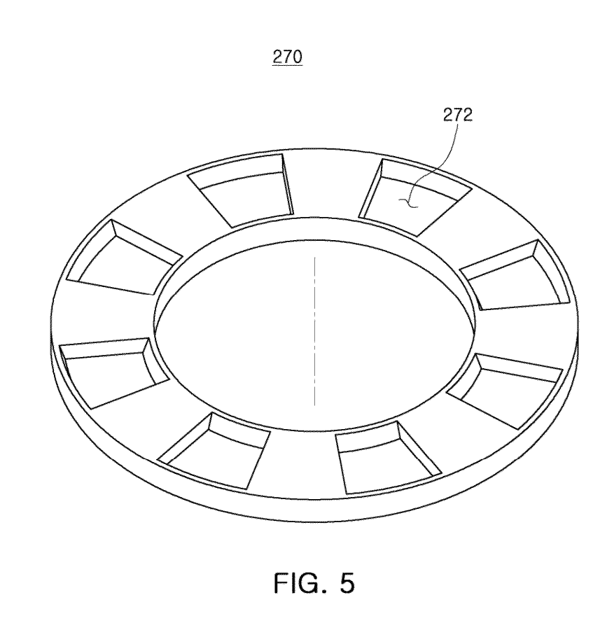

FIG. 1 is a schematic cross-sectional view showing a spindle motor according to an exemplary embodiment of the present disclosure, FIG. 2 is an enlarged view of part A of FIG. 1, FIG. 3 is a perspective view showing a strength reinforcing member provided in the spindle motor according to an exemplary embodiment of the present disclosure, and FIG. 4 is a perspective view showing a stator core provided in the spindle motor according to an exemplary embodiment of the present disclosure.

Referring to FIGS. 1 through 4, a spindle motor 100 according to an exemplary embodiment of the present disclosure may include, for example, a base member 110, a lower thrust member 120, a shaft 130, a rotating member 140, a cap member 150, a stator core 160, and a strength reinforcing member 170.

Meanwhile, the spindle motor 100 according to an exemplary embodiment of the present disclosure may be, for example, a motor used in an information recording and reproducing device such as a recording disk driving device to be described below, or the like.

The base member 110 may have an installation part 112 extended upwardly in an axial direction. An installation hole 112a into which the lower thrust member 120 as described above is inserted may be formed in the installation part 112 and the installation part 112 may have a cylindrical shape.

Meanwhile, a support surface 112b supporting the stator core 160 may be formed at an outer peripheral surface of the installation part 112. As an example, the stator core 160 may be fixedly installed to the installation part 112 in a state in which it is seated on the support surface 112b of the installation part 112.

In addition, the base member 110 may include a coupling hole 114 formed therein so as to be disposed around the installation part 112. That is, the coupling hole 114 may be formed in the base member 110 so as to be disposed below the stator core 160.

In addition, the base member 110 may be manufactured by die-casting using an aluminum material.

Here, terms with respect to directions will be defined. As viewed in FIG. 1, the axial direction refers to a vertical direction, that is, a direction from a lower end portion of the shaft 130 toward an upper end portion thereof or a direction from the upper end portion of the shaft 130 toward the lower end portion thereof, and a radial direction refers to a horizontal direction, that is, a direction from the shaft 130 toward an outer peripheral surface of the rotating member 140 or a direction from the outer peripheral surface of the rotating member 140 toward the shaft 130.

In addition, a circumferential direction refers to a rotation direction along an outer peripheral surface of the shaft 130.

The lower thrust member 120 may be fixedly installed to an inner peripheral surface of the installation part 112 and have a cup shape. As an example, the lower thrust member 120 may include a disk part 122 having a circular plate shape, an extension part 124 extended upwardly from an edge of the disk part 122 in the axial direction, and a shaft coupling part 126 insertedly installed into the lower end portion of the shaft 130.

Meanwhile, the lower thrust member 120 may be installed to the installation part 112 of the base member 110 through an adhesive. In other words, an outer peripheral surface of the extension part 124 may be adhered to an inner peripheral surface of the installation part 112 by the adhesive.

In addition, an inner peripheral surface of the extension part 124 may serve to form a liquid-vapor interface together with the rotating member 140. That is, the inner peripheral surface of the extension part 124 and an opposite surface of the rotating member 140 disposed to face the inner peripheral surface of the extension part 124 form a sealing part, such that the liquid-vapor interface may be formed.

In addition, the shaft coupling part 126 may protrude from a central portion of the disk part 122 to thereby be inserted into the lower end portion of the shaft 130. In addition, the shaft 130 and the shaft coupling part 126 may be coupled to each other by an adhesive.

However, the present disclosure is not limited thereto, but the shaft 130 and the shaft coupling part 126 may be coupled to each other by any one of an adhesive method, a welding method, and a press-fitting method.

The shaft 130 may be fixedly installed into the lower thrust member 120 as described above. That is, the spindle motor 100 according to an exemplary embodiment of the present disclosure may be a shaft fixed type motor. Meanwhile, the lower end portion of the shaft 130 may be provided with a mounting hole 132 into which the shaft coupling part 126 is inserted, and the mounting hole 132 may be stepped, such that the upper end portion thereof may be provided with a screw part 134.

The screw part 134 may be formed in the shaft 130 in order to be coupled to a case of a recording disk driving device to be described below.

In addition, a flange part 136 may be formed at the upper end portion of the shaft 130 in order to form the liquid-vapor interface together with the rotating member 140. Further, an outer peripheral surface of the flange part 136 may be inclined so that the liquid-vapor interface may be formed.

The rotating member 140 may rotate based on the shaft 130. Meanwhile, the rotating member 140 may include a sleeve 142 forming a bearing clearance together with the lower thrust member 120 and the shaft 130 and a rotor hub 144 extended from the sleeve 142.

Meanwhile, an insertion groove 141 into which the flange part 136 of the shaft 130 is insertedly disposed may be formed in the rotating member 140.

The sleeve 142 may mean a portion disposed between the flange part 136 of the shaft 130 and the lower thrust member 120. In addition, the bearing clearance may be filled with a lubricating fluid, and one liquid-vapor interface may be formed in each upper and lower portions of the bearing clearance. That is, one liquid-vapor interface may be formed in a space formed by a lower end portion of an outer peripheral surface of the sleeve 142 and the extension part 124 of the lower thrust member 120, and the other liquid-vapor interface may be formed in a space formed by the outer peripheral surface of the flange part 136 of the shaft 130 and the opposite surface of the rotating member 140.

Meanwhile, the sleeve 142 may include a shaft hole 142a formed therein, wherein the shaft hole 142a has the shaft 130 penetrating therethrough. In addition, upper and lower radial dynamic pressure grooves (not shown) may be formed in at least one of an inner peripheral surface of the sleeve 142 or the outer peripheral surface of the shaft 130. The upper and lower radial dynamic pressure grooves may be disposed to be spaced apart from each other in the axial direction by a predetermined interval, and generate fluid dynamic pressure in the radial direction at the time of rotation of the sleeve 142. Therefore, the rotating member 140 may more stably rotate.

The rotor hub 144 may be extended from the sleeve 142. Meanwhile, although the case in which the rotor hub 144 and the sleeve 142 are formed integrally with each other is described in the present exemplary embodiment by way of example, the present disclosure is not limited thereto. The rotor hub 144 and the sleeve 142 may be separately manufactured and coupled to each other.

Meanwhile, the rotor hub 144 may include a body 144a having a disk shape, a magnet mounting part 144b extended downwardly from an edge of the body 144a in the axial direction, and a disk support part 144c extended from a distal end of the magnet mounting part 144b in the radial direction.

In addition, the magnet mounting part 144b may include a driving magnet 102 fixedly installed on an inner surface thereof. Therefore, an inner surface of the driving magnet 102 may be disposed to face the stator core 160.

Meanwhile, the driving magnet 102 may be a permanent magnet generating magnetic force having a predetermined strength by alternately magnetizing an N pole and an S pole thereof in a circumferential direction.

Here, a rotational driving scheme of the rotating member 140 will be simply described. When power is applied to a coil 104 wound around the stator core 160, driving force rotating the rotating member 140 may be generated by electromagnetic interaction between the stator core 160 including the coil 104 wound therearound and the driving magnet 102, thereby rotating the rotating member 140.

That is, the rotating member 140 may be rotated by the electromagnetic interaction between the driving magnet 102 and the stator core 160 including the coil 104 wound therearound and disposed to face the driving magnet 102.

The cap member 150 is installed on the rotating member 140 so as to be disposed over the liquid-vapor interface disposed in the space formed by the flange part 136 of the shaft 130 and the opposite surface of the rotating member 140. That is, the cap member 150 may be installed on the rotating member 140 so as to prevent the lubricating fluid filled in the bearing clearance from being leaked and scattered at the time of external impact. Meanwhile, the cap member 150 may have a circular ring shape or a plate shape.

The stator core 160 may be fixedly installed to the installation part 112 of the base member 110. Meanwhile, as shown in detail in FIG. 4, the stator core 160 may have a core back 162 having a circular ring shape, a plurality of teeth 164 extended from the core back 162 in the radial direction, and magnet facing part 166 extended from distal ends of the plurality of teeth 164 in the circumferential direction.

Meanwhile, the stator core 160 may include a winding groove 168 and a protrusion part 169 formed therein, wherein the winding groove 168 and the protrusion part 169 may be formed at the teeth 164. In addition, the winding groove 168 may be depressed from an upper surface of the teeth 164, and the protrusion part 169 may protrude from a bottom surface of the teeth 164.

Meanwhile, the winding groove 168 and the protrusion part 169 may be formed at the same time by press processing.

A concave groove 172 disposed to face the protrusion part 169 may be formed in the strength reinforcing member 170, as shown in detail in FIG. 3. In addition, the strength reinforcing member 170 may be coupled to the coupling hole 114 of the base member 110. Meanwhile, the strength reinforcing member 170 may be formed of a metal material in order to alleviate strength deterioration by the concave groove 172.

Meanwhile, the strength reinforcing member 170 may have a shape corresponding to the coupling hole 114. As an example, the strength reinforcing member 170 may have a circular ring shape.

In addition, the concave groove 172 may have a ring shape.

Further, the coil 104 wound around the stator core 160 may be insertedly disposed in the concave groove 172 disposed to face the protrusion part 169.

As described above, the coil 104 wound around the stator core 160 is insertedly disposed in the winding groove 168 and the concave groove 172, such that a thickness increase by the coil 104 may be prevented. In other words, the thickness increase by the coil 104 may be prevented, such that thinness may be implemented.

Further, strength deterioration of the base member 110 by the concave groove 172 may be decreased. That is, the concave groove 172 is formed in the strength reinforcing member 170 formed of the metal material and the strength reinforcing member 170 is installed in the base member 110, such that strength deterioration of the base member 110 may be decreased.

Meanwhile, the case in which the strength reinforcing member 170 and the base member 110 are separately manufactured and coupled to each other by at least one of an adhesion method, a welding method, and a press-fitting method is described by way of example in the present exemplary embodiment, but the present disclosure is not limited thereto. The strength reinforcing member 170 and the base member 110 may be formed integrally with each other.

That is, the strength reinforcing member formed of the metal material may be formed integrally with the base member 110 by insert injection.

Hereinafter, a strength reinforcing member provided in a spindle motor according to another exemplary embodiment of the present disclosure will be described with reference to the accompanying drawing. That is, a modified example of the strength reinforcing member will be described. However, the same reference numerals will be used to describe the same components as the above-mentioned components.

FIG. 5 is a perspective view showing the strength reinforcing member provided in the spindle motor according to another exemplary embodiment of the present disclosure.

Referring to FIG. 5, concave grooves 272 disposed to face the protrusion part 169 (see FIG. 2) may be formed in the strength reinforcing member 270. In addition, the strength reinforcing member 270 may be coupled to the coupling hole 114 (see FIG. 2) of the base member 110 (see FIG. 2). Meanwhile, the strength reinforcing member 270 may be formed of a metal material in order to alleviate strength deterioration by the concave groove 272.

Meanwhile, the strength reinforcing member 270 may have a shape corresponding to the coupling hole 114. As an example, the strength reinforcing member 270 may have a circular ring shape.

In addition, a plurality of concave grooves 272 may be disposed to be spaced apart from each other in the circumferential direction. That is, the plurality of concave grooves 272 may be formed to be disposed below the teeth 164 (see FIG. 4) of the stator core 160 (see FIG. 2).

Further, the coil 104 (see FIG. 2) wound around the stator core 160 may be insertedly disposed in the concave groove 272 disposed to face the protrusion part 169.

As described above, the coil 104 wound around the stator core 160 is insertedly disposed in the winding groove 168 (see FIG. 2) and the concave groove 272, such that a thickness increase by the coil 104 may be prevented. In other words, the thickness increase by the coil 104 may be prevented, such that thinness may be implemented.

In addition, the plurality of concave grooves 272 disposed to be spaced apart from each other in the circumferential direction are formed, such that strength deterioration of the strength reinforcing member 270 may be further decreased. In other words, strength deterioration by formation of the concave groove 272 may be suppressed.

Hereinafter, a recording disk driving device according to an exemplary embodiment of the present disclosure will be described with reference to the accompanying drawing.

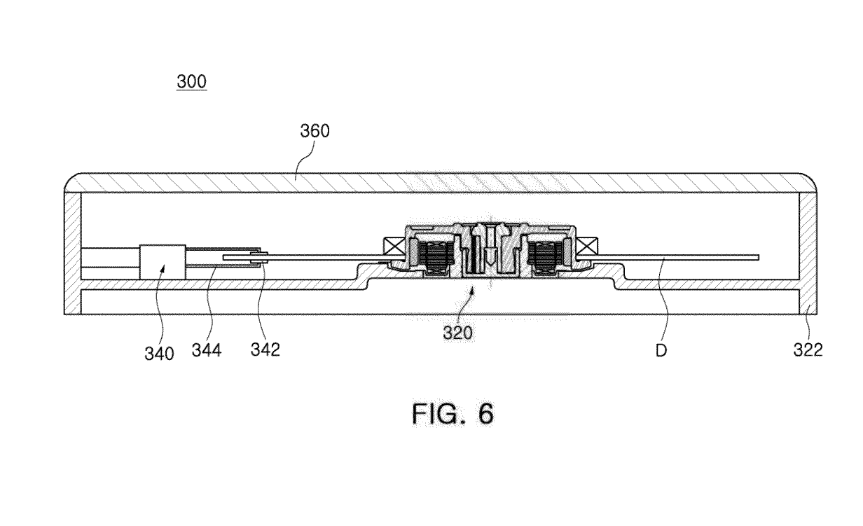

FIG. 6 is a schematic cross-sectional view showing a recording disk driving device according to an exemplary embodiment of the present disclosure.

Referring to FIG. 6, the recording disk driving device 300 according to an exemplary embodiment of the present disclosure may include, for example, a spindle motor 320, ahead transfer part 340, and an upper case 360.

The spindle motor 320 may be any one of the above-mentioned spindle motors according to an exemplary embodiment and another exemplary embodiment of the present disclosure, and a recording disk D is mounted in the spindle motor 320.

The head transfer part 340 may transfer a head 342 detecting information of the recording disk D mounted in the spindle motor 320 to a surface of the recording disk D of which the information is to be detected. The head 342 may be disposed on a support part 344 of the head transfer part 340.

The upper case 360 may be coupled to a base member 322 in order to form an internal space for accommodating the spindle motor 320 and the head transfer part 340.

As set forth above, according to exemplary embodiments of the present disclosure, thinness may be implemented and rigidity deterioration may be prevented by the strength reinforcing member having the concave groove.

While exemplary embodiments have been shown and described above, it will be apparent to those skilled in the art that modifications and variations could be made without departing from the scope of the present invention as defined by the appended claims.

What is claimed is:

1. A spindle motor comprising:
a base member including an installation part extended upwardly in an axial direction and a coupling hole formed to be disposed around the installation part;
a stator core including winding grooves into which a coil is inserted and wound therearound and protrusion parts formed on a surface opposite to a surface in which the wounding groove is formed, and fixedly installed in the installation part; and
a strength reinforcing member including a concave groove formed therein so as to be disposed to face the protrusion part, and coupled to the coupling hole in order to reinforce strength of the base member.

2. The spindle motor of claim 1, wherein the base member is formed by die-casting, and the strength reinforcing member is formed of a metal material.

3. The spindle motor of claim 1, wherein the winding groove and the protrusion part are formed by press processing.

4. The spindle motor of claim 1, wherein the strength reinforcing member has a ring shape.

5. The spindle motor of claim 1, wherein a plurality of concave grooves are disposed to be spaced apart from each other in a circumferential direction.

6. The spindle motor of claim 1, wherein the plurality of concave grooves have a circular ring shape.

7. A spindle motor comprising:
a base member including an installation part extended upwardly in an axial direction and a concave groove formed to be disposed around the installation part; and
a stator core including winding grooves into which a coil is inserted and wound therearound and protrusion parts formed on a surface opposite to a surface in which the wounding groove is formed, and fixedly installed in the installation part,
wherein the concave groove is formed in a strength reinforcing member.

8. The spindle motor of claim 7, wherein the strength reinforcing member is formed of a metal material, and the base member is formed together with the strength reinforcing member by insert injection molding.

9. The spindle motor of claim 8, wherein the concave groove has a circular ring shape.

10. A recording disk driving device comprising:
the spindle motor of claim 1, rotating a recording disk;
a head transfer part transferring a head detecting information stored on the recording disk mounted in the spindle motor to the recording disk; and
an upper case coupled to a base member provided in the spindle motor so as to form an internal space for accommodating the spindle motor and the head transfer part.
